(19) United States
(12) Patent Application Publication
(10) Pub. No.: US 2020/0328543 A1
(43) Pub. Date: Oct. 15, 2020

(54) MULTI-PIN CONNECTOR PLUG AND SOCKET

(71) Applicant: KONINKLIJKE PHILIPS N.V., EINDHOVEN (NL)

(72) Inventors: Edwin Gerardus Johannus Maria BONGERS, THORN (NL); Johannes WEDA, NIJMEGEN (NL)

(21) Appl. No.: 16/095,707

(22) PCT Filed: Apr. 24, 2017
(86) PCT No.: PCT/EP2017/059589

§ 371 Date: Oct. 23, 2018

(30) Foreign Application Priority Data
Apr. 25, 2016 (EP) 16166772.0

(51) Int. Cl. H01R 12/72; H01R 13/703

(52) U.S. Cl. CPC H01R 12/727; H01R 13/64; H01R 13/7031

(57) ABSTRACT

The present invention relates to multi-pin connector plugs (10-18) for coupling with a multi-pin connector socket along a coupling direction and to multi-pin connector sockets (20-25, 27, 28) for coupling with a multi-pin connector plug along a coupling direction. The present invention relates further to a wearable device, such as sensors or wearables.

### FIELD OF THE INVENTION

The present invention relates to multi-pin connector plugs for coupling with a multi-pin connector socket along a coupling direction and to multi-pin connector sockets for coupling with a multi-pin connector plug along a coupling direction. The present invention relates further to a wearable device, such as sensors or wearables.

### BACKGROUND OF THE INVENTION

Many clinical sensors are flat for ease of use and are disposed after usage for hygienic reasons. These sensors for e.g. multi-lead ECG, multi-lead EEG or passive core-body temperature need to have multi-pin connectors that are flat and cheap as well. Existing multi-pin connectors are, however, bulky and expensive. Such connectors are not suited for disposable sensors and inconvenient to apply in clinical practice for a sensor.

EP 2590273 A2 discloses a dual orientation connector having a connector tab with first and second major opposing sides and a plurality of electrical contacts carried by the connector tab. The plurality of contacts includes a first set of external contacts formed at the first major side and a second set of external contacts formed at the second major side. Each individual contact in the first plurality of contacts is electrically connected within the tab or body to a corresponding contact in the second plurality of contacts. The first plurality of contacts are symmetrically spaced with the second plurality of contacts and the connector tab is shaped to have 180 degree symmetry so that it can be inserted and operatively coupled to a corresponding receptacle connector in either of two insertion orientations.

### SUMMARY OF THE INVENTION

It is an object of the present invention to provide multi-pin connector plugs and multi-pin connector sockets which are less bulky and less expensive and are hence suitable for use with disposable sensors and for application in clinical practice. Further, electrical safety shall be ensured by the multi-pin connector plugs and the multi-pin connector sockets.

In a first aspect of the present invention a multi-pin connector plug for coupling with a multi-pin connector socket along a coupling direction is presented, said multi-pin connector plug comprising:
a carrier plate,
a plug interface arranged in an interface area of the carrier plate for input of signals from and/or output of signals to a coupled device, said signals including one or more power supply signals, and
a plurality of plug connection pads arranged in a two-dimensionally distributed manner in a connection pad area of the carrier plate for input of signals from and/or output of signals to said multi-pin connector socket, said plug connection pads including one or more plug power supply connection pads for input of said one or more power supply signals from and/or output of said one or more power supply signals to corresponding socket power supply connection pads of said multi-pin connector socket,
   wherein said one or more plug power supply connection pads are arranged either at a front face of the connection pad area of the carrier plate, or at the largest distance from the front face of the connection pad area of the carrier plate among the plug connection pads, or in one or more rows parallel to said coupling direction in which no other plug connection pads are arranged.

In a second aspect of the present invention a multi-pin connector plug for coupling with a multi-pin connector socket along a coupling direction is presented, said multi-pin connector plug comprising:
a carrier plate,
a plug interface arranged in an interface area of the carrier plate for input of signals from and/or output of signals to a coupled device, said signals including one or more power supply signals, and
a plurality of plug connection pads arranged in a two-dimensionally distributed manner in a connection pad area of the carrier plate for input of signals from and/or output of signals to said multi-pin connector socket,
   said plug connection pads including one or more plug power supply connection pads for input of said one or more power supply signals from and/or output of said one or more power supply signals to corresponding socket power supply connection pads of said multi-pin connector socket, and
   said plug connection pads including at least two plug coupling pads, which are short-circuited and arranged for short-circuiting at least two corresponding socket coupling pads of said multi-pin connector socket if said multi-pin connector plug is correctly coupled with said multi-pin connector socket, wherein current can only flow through said one or more plug power supply connection pads and said socket power supply connection pads, if said at least two plug coupling pads are short-circuiting said at least two corresponding socket coupling pads.

In a third aspect of the present invention a multi-pin connector socket for coupling with a multi-pin connector plug along a coupling direction, said multi-pin connector socket is presented, said multi-pin connector socket comprising
a socket casing having a plug opening for insertion of said multi-pin connector plug,
a connection plate arranged on one side of said plug opening,
a socket interface for input of signals from and/or output of signals to an coupling element, said signals including one or more power supply signals, and
a plurality of socket connection pads arranged in a two-dimensionally distributed manner in a connection pad area of the connection plate for input of signals from and/or output of signals to said multi-pin connector plug,
   said socket connection pads including one or more socket power supply connection pads for input of said one or more power supply signals from and/or output of said one or more power supply signals to corresponding plug power supply connection pads of said multi-pin connector plug,
   wherein said one or more socket power supply connection pads are arranged either at a rearward end surface of the plug opening, or at the shortest distance from the forward entrance of said plug opening among the socket connection pads, or in one or more rows parallel to said coupling direction in which no other socket connection pads are arranged.

In a fourth aspect of the present invention a multi-pin connector socket for coupling with a multi-pin connector plug along a coupling direction, said multi-pin connector socket is presented, said multi-pin connector socket comprising
a socket casing having a plug opening for insertion of said multi-pin connector plug,
a connection plate arranged on one side of said plug opening,
a socket interface for input of signals from and/or output of signals to an coupling element, said signals including one or more power supply signals, and
a plurality of socket connection pads arranged in a two-dimensionally distributed manner in a connection pad area of the connection plate for input of signals from and/or output of signals to said multi-pin connector plug,
   said socket connection pads including one or more socket power supply connection pads for input of said one or more power supply signals from and/or output of said one or more power supply signals to corresponding plug power supply connection pads of said multi-pin connector plug,
   wherein said socket connection pads include at least two socket coupling pads, which are short-circuited and arranged for short-circuiting at least two corresponding plug coupling pads of said multi-pin connector plug if said multi-pin connector socket is correctly coupled with said multi-pin connector plug, wherein current can only flow through said one or more socket power supply connection pads and said plug power supply connection pads if said at least two socket coupling pads, are short-circuiting said at least two corresponding plug coupling pads.

In a fifth aspect a wearable device is presented, comprising
a functional unit for performing a predetermined function and
a multi-pin connector plug as disclosed herein, whose plug interface is connected with said functional unit for input of signals from and/or output of signals to said functional unit, said signals including one or more power supply signals.

In a sixth aspect a multi-pin connector socket arrangement is presented, comprising
a coupling element, in particular a cable and/or a power supply unit and/or a signal processing unit and/or a wireless signal interface,
a multi-pin connector socket as disclosed herein, whose socket interface is connected with said coupling element, for input of signals from and/or output of signals to coupling element, said signals including one or more power supply signals.

One of the ideas of the present invention is to save space by arranging the connection pads not only located next to each other but also after each other, i.e. in a two-dimensionally distributed manner, and/or by arranging the connection pads on both sides of the connector plug.

Another idea relates to the arrangement of one or more power supply connection pads at the connector plug and/or the connector socket such that shorts are prevented during insertion and extraction of the connector plug into/from the connector socket.

Still another idea relates to the use of at least two plug coupling pads, which are short-circuited and arranged for short-circuiting at least two corresponding socket coupling pads, if said multi-pin connector plug is correctly coupled with said multi-pin connector socket. This provides that current can only flow through said one or more plug power supply connection pads and said socket power supply connection pads, if said at least two plug coupling pads are short-circuiting said at least two corresponding socket coupling pads. Hence, also in this way shorts are prevented during insertion and extraction of the connector plug into/from the connector socket.

According to one embodiment of the multi-pin connector plug the plug connection pads are arranged on opposite surfaces of said carrier plate. Thus, more pins can be provided. Further, the plug may be inserted into the socket in two different orientations.

In a practical embodiment the carrier plate is made of a flexible material, in particular a flexible foil.

Manufacturing can be made easier by providing that part of the carrier plate is folded back by 180° so that plug connection pads are arranged on opposite surfaces of said carrier plate.

The multi-pin connector plug may have an asymmetrical mechanical design to allow coupling with said multi-pin connector socket only in one predetermined position of said multi-pin connector plug.

The wearable device comprises a functional unit for performing a predetermined function in addition to the multi-pin connector plug, whose plug interface is connected with said functional unit for input of signals from and/or output of signals to said functional unit, said signals including one or more power supply signals.

Preferably, the functional unit comprises one or more sensors for sensing one or more sensor signals. Hereby, the multi-pin connector plug is configured for output of said sensor signals sensed by said one or more sensors and for input said one or more power supply signals for power supply of said function unit.

In a practical embodiment said functional unit is arranged on said carrier plate.

### BRIEF DESCRIPTION OF THE DRAWINGS

These and other aspects of the invention will be apparent from and elucidated with reference to the embodiment(s) described hereinafter. In the following drawings

FIG. 1 shows a first embodiment of a multi-pin connector plug and socket according to the present invention,

FIG. 2 shows a second embodiment of a multi-pin connector plug and socket according to the present invention,

FIG. 3 shows a third embodiment of a multi-pin connector plug and socket according to the present invention,

FIG. 4 shows a fourth embodiment of a multi-pin connector plug and socket according to the present invention,

FIG. 5 shows a fifth embodiment of a multi-pin connector plug and socket according to the present invention,

FIG. 6 shows a sixth embodiment of a multi-pin connector plug and socket according to the present invention,

FIG. 7 shows a seventh embodiment of a multi-pin connector plug according to the present invention,

FIG. 8 shows an eighth embodiment of a multi-pin connector plug and socket according to the present invention,

FIG. 9 shows an embodiment of a wearable device and a multi-pin socket arrangement according to the present invention, and

FIG. 10 shows a ninth embodiment of a multi-pin connector plug and socket according to the present invention.

### DETAILED DESCRIPTION OF THE INVENTION

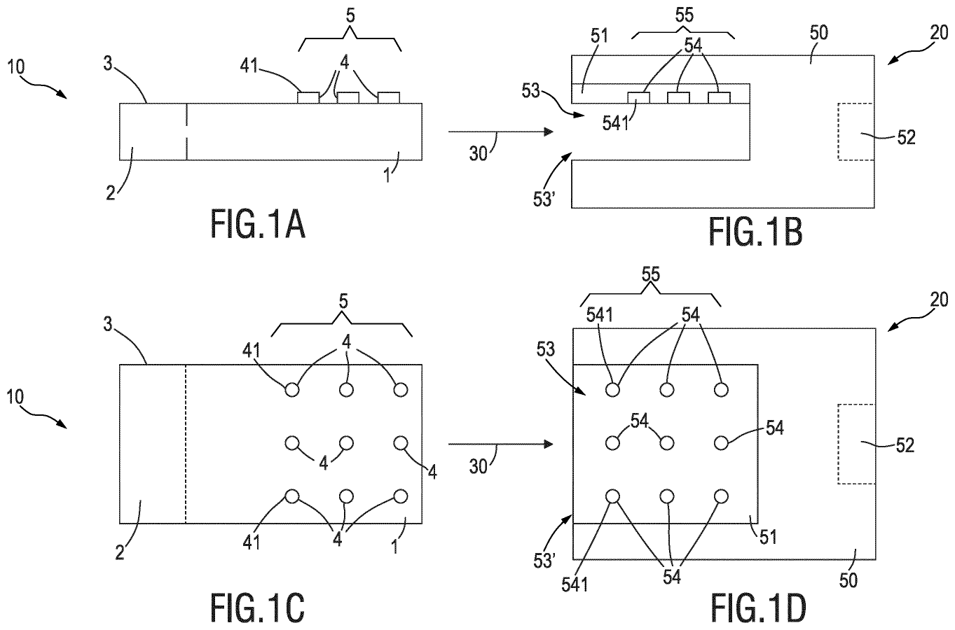

FIG. 1 shows a first embodiment of a multi-pin connector plug 10 and socket 20 according to the present invention, which can be coupled together along a coupling direction 30. Hereby, FIG. 1A shows a side view of the plug 10, FIG. 1B shows a side view of the socket 20, FIG. 1C shows a top view of the plug 10, and FIG. 1D shows a top view of the socket 20.

The multi-pin connector plug 10 comprises a carrier plate 1, e.g. a PCB or a flexible material, a flexible foil. The multi-pin connector plug 10 further comprises a plug interface 2 arranged in an interface area 3 of the carrier plate 1 for input of signals from and/or output of signals to a coupled device, for instance a sensor, such as vital signs sensor (e.g. for monitoring heart rate, body movement, respiration, core body temperature, etc. Said signals include one or more power supply signals, in particular for power supply of the coupled device supplied from the socket 20 via the plug 10.

The multi-pin connector plug 10 further comprises a plurality of plug connection pads 4 arranged in a two-dimensionally distributed manner in a connection pad area 5 of the carrier plate 1 for input of signals from and/or output of signals to the socket 20. Said plug connection pads 4 include one or more (in the depicted embodiment two) plug power supply connection pads 41 for input of two power supply signals (e.g. a DC and ground or a +DC and −DC signal) from and/or output of two power supply signals to corresponding socket power supply connection pads 541 of the socket 20. In the embodiment of the plug 10 shown in FIG. 1 the two plug power supply connection pads 41 are arranged at the largest distance from the front face 6 of the connection pad area 5 of the carrier plate 1 among the plug connection pads 4, i.e. no other of the plug connection pads 4 are farther away from the front face than the two plug power supply connection pads 41.

The multi-pin connector socket 20 comprises a socket casing 50 having a plug opening 53 for insertion of the plug 10. The multi-pin connector socket 20 further comprises a connection plate 51 arranged on one side of said plug opening 53, which plate may be mounted on the inner surface of the plug opening 53 or may even be integral part of the socket casing (e.g. of the same material or represented by the inner surface of the plug opening 53. The multi-pin connector socket 20 further comprises a socket interface 52 for input of signals from and/or output of signals to a coupling element 41, e.g. a power supply unit (e.g. a battery) or a cable to an external entity (e.g. a measurement module, or processing module or patient monitor), wherein said signals generally include one or more power supply signals.

The multi-pin connector socket 20 further comprises a plurality of socket connection pads 54 arranged in a two-dimensionally distributed manner in a connection pad area 55 of the connection plate 51 for input of signals from and/or output of signals to the plug 10. The socket connection pads 54 hereby include one or more socket power supply connection pads 541 for input of said one or more (in this embodiment two) power supply signals from and/or output of said one or more power supply signals to the corresponding plug power supply connection pads 41 of the plug 10. In the embodiment of the socket 20 shown in FIG. 1 the two socket power supply connection pads 541 are at the shortest distance from the forward entrance 53′ of said plug opening 53 among the socket connection pads 54, i.e. no other of the socket connection pads 54 are closer to the forward entrance 53′ than the two socket power supply connection pads 541.

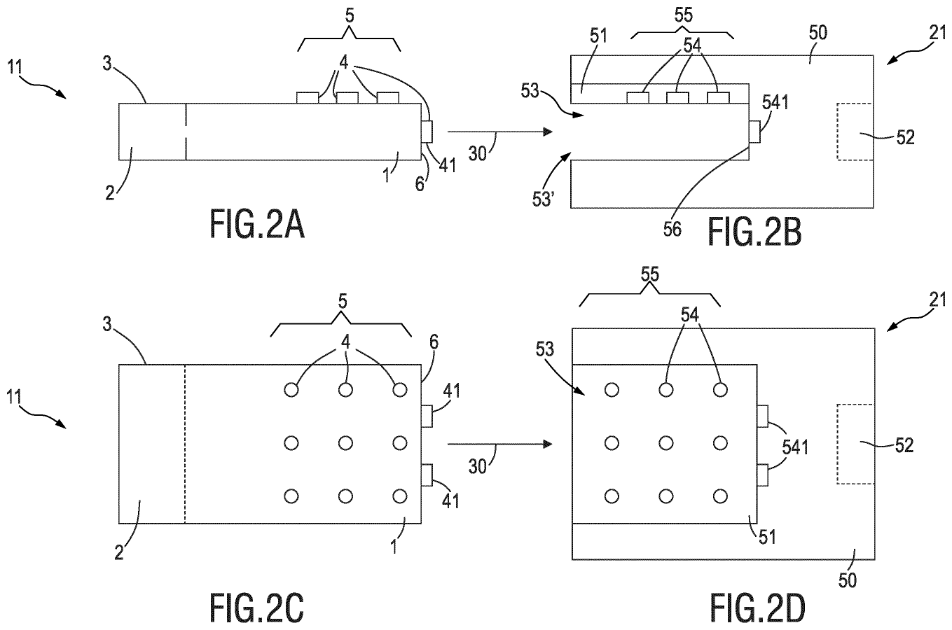

FIG. 2 shows a second, alternative embodiment of a multi-pin connector plug 11 and socket 21 according to the present invention. In the multi-pin connector plug 11 the two plug power supply connection pads 41 are arranged at the front face 6 of the connection pad area 5 of the carrier plate 1. In the multi-pin connector socket 21 the two socket power supply connection pads 541 are arranged at the rearward end surface 56 of the plug opening 53.

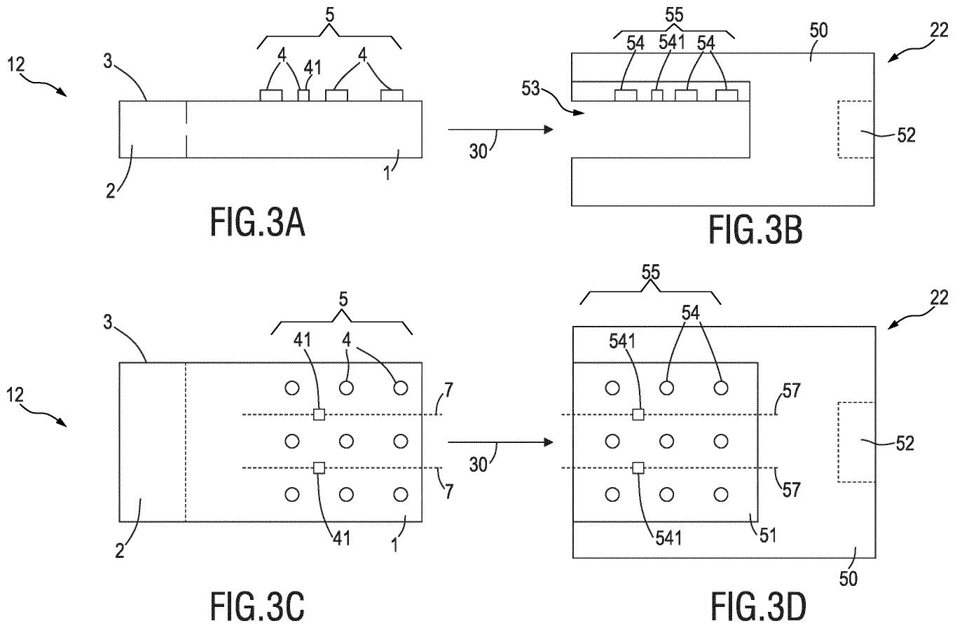

FIG. 3 shows a third, alternative embodiment of a multi-pin connector plug 12 and socket 22 according to the present invention. In the multi-pin connector plug 12 the two plug power supply connection pads 41 are arranged in one or more rows 7 parallel to said coupling direction 30 in which no other plug connection pads 4 are arranged. In the multi-pin connector socket 22 the two socket power supply connection pads 541 are arranged in one or more rows 57 parallel to said coupling direction 30 in which no other socket connection pads 54 are arranged.

With the arrangements shown in FIGS. 1 to 3 short circuits between plug power supply connection pads 41 and any socket connection pads 54 and between socket power supply connection pads 541 and any plug connection pads 4 during insertion of the plug into the socket and during extraction of the plug from the socket are effectively prevented.

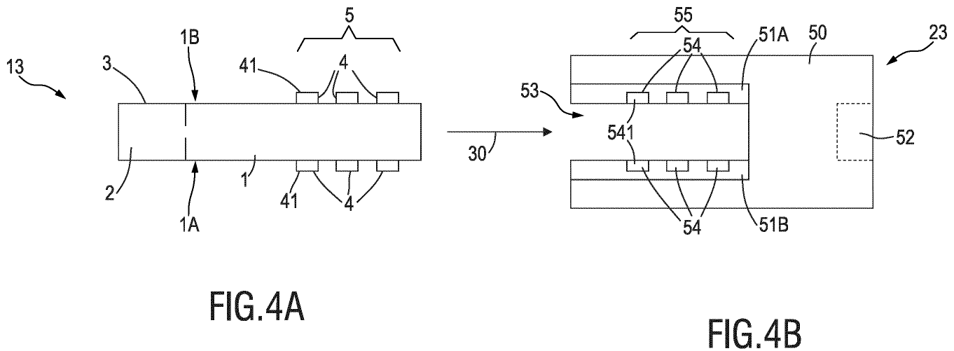

FIG. 4 shows a fourth embodiment of a multi-pin connector plug 13 and socket 23 according to the present invention. In this embodiment, in multi-pin connector plug 13 the plug connection pads 4 are arranged on opposite surfaces 1A, 1B of said carrier plate 1. The two plug power supply connection pads 41 are arranged at the largest distance from the front face 6 of the connection pad area 5 of the carrier plate 1 among the plug connection pads 4, as shown in FIG. 1. The multi-pin connector socket 23 comprises a further connection plate 1B arranged on a side of said plug opening 53 opposite the connection plate 1A, wherein a plurality of socket connection pads 54 are arranged in a two-dimensionally distributed manner in a connection pad area 55 of said further connection plate 1B.

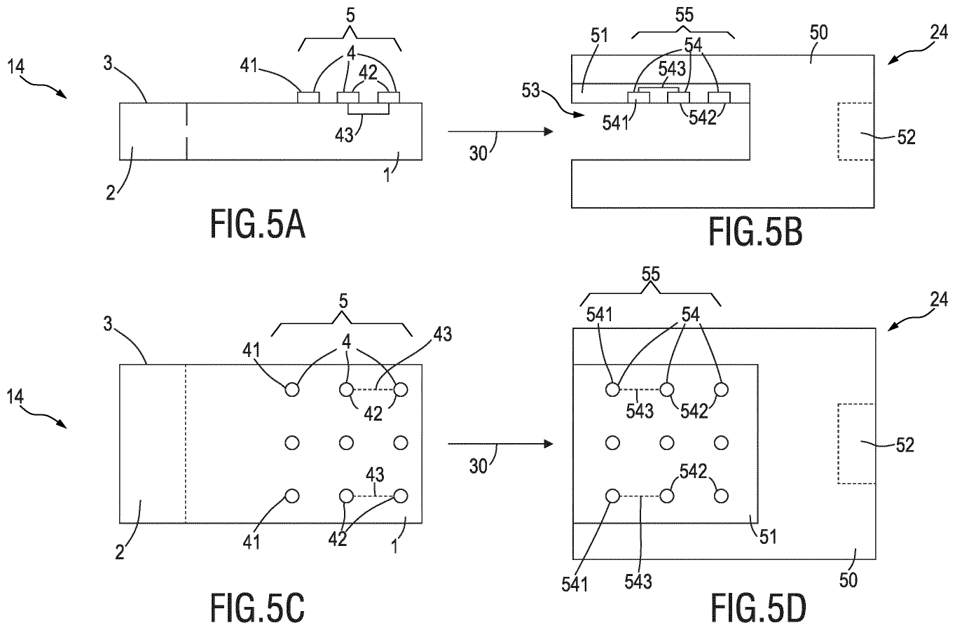

FIG. 5 shows a fifth embodiment of a multi-pin connector plug 14 and socket 24 according to the present invention. In this embodiment the two plug power supply connection pads 41 and the two socket power supply connection pads 541 are arranged as illustrated in FIG. 1, but could also be arranged differently, and also the number of plug power supply connection pads 41 and socket power supply connection pads 541 could be different. The plug connection pads 4 include at least two, in this embodiment two pairs of two plug coupling pads 42, plug coupling pads 42, which are short-circuited, e.g. by use of a galvanic connection 43, and arranged for short-circuiting at least two, in this embodiment two pairs of two socket coupling pads 542, corresponding socket coupling pads 542 of said multi-pin connector socket if the multi-pin connector plug 14 is correctly coupled with the multi-pin connector socket 24. Current can only flow through the plug power supply connection pads 41 and the socket power supply connection pads 541 if the plug coupling pads 42 are short-circuiting the corresponding socket coupling pads 542. In particular, if the multi-pin connector plug 14 is correctly coupled with the multi-pin connector socket 24, as shown in FIG. 5E, current provided by the multi-pin connector socket 24 flows through the two galvanic connection 43 and 543 to the socket power supply connection pads 541, which transfers the current to the plug power supply connection pads 41, so that it can be used by the multi-pin connector plug 14.

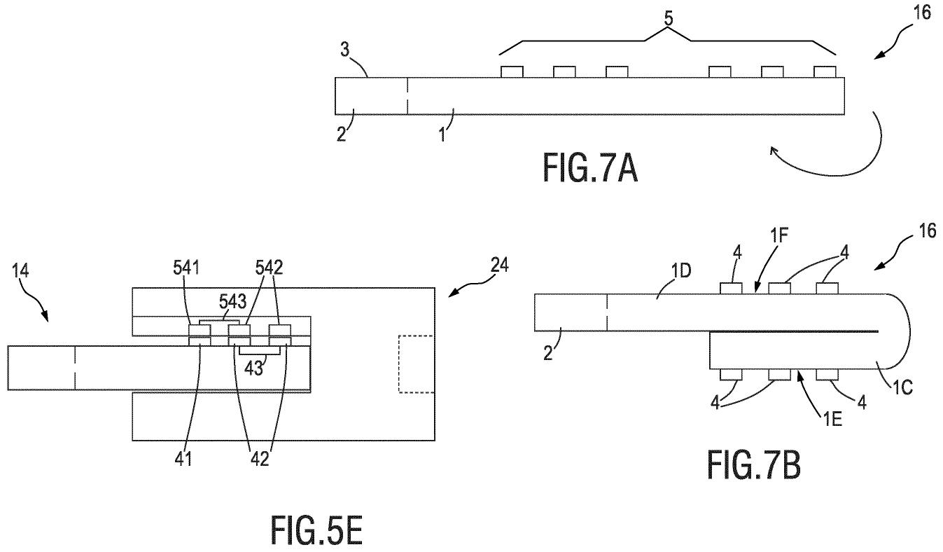

FIG. 6 shows a sixth embodiment of a multi-pin connector plug 15 and socket 25 according to the present invention, which is quite similar to the fifth embodiment. In this embodiment the positions of the various pads are changed, but the general idea of using coupling pads 42, 542 and galvanic connections 43, 543 is generally the same to make sure that current can only flow if the multi-pin connector plug 15 is correctly coupled with the multi-pin connector socket 25.

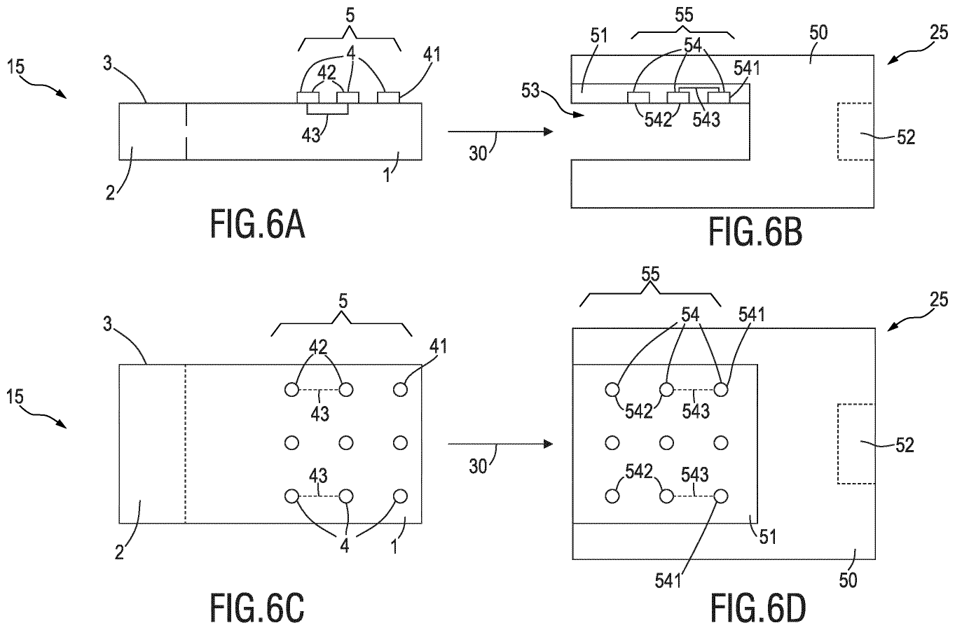

Clearly having connection pads on the top and bottom of the plug, as shown in FIG. 4A, is somewhat less cheap than single-sided plugs. Building such plugs involves using multi-layer PCB/flex foil manufactured in standard ways. The multi-layer costs can, however, be reduced even more by flipping over the single layer flex foil. FIG. 7 shows a seventh embodiment of a multi-pin connector plug 16 according to the present invention using this approach. In this embodiment the carrier plate 1 is made of a flexible material, in particular a flexible foil. The front part 1C of the carrier plate 1 is folded back by 180° with respect to the rear part 1D so that plug connection pads 4 are arranged on opposite surfaces 1E, 1F of said carrier plate 1. In this way a double sided multi-pin connector plug 16 can be easily manufactured.

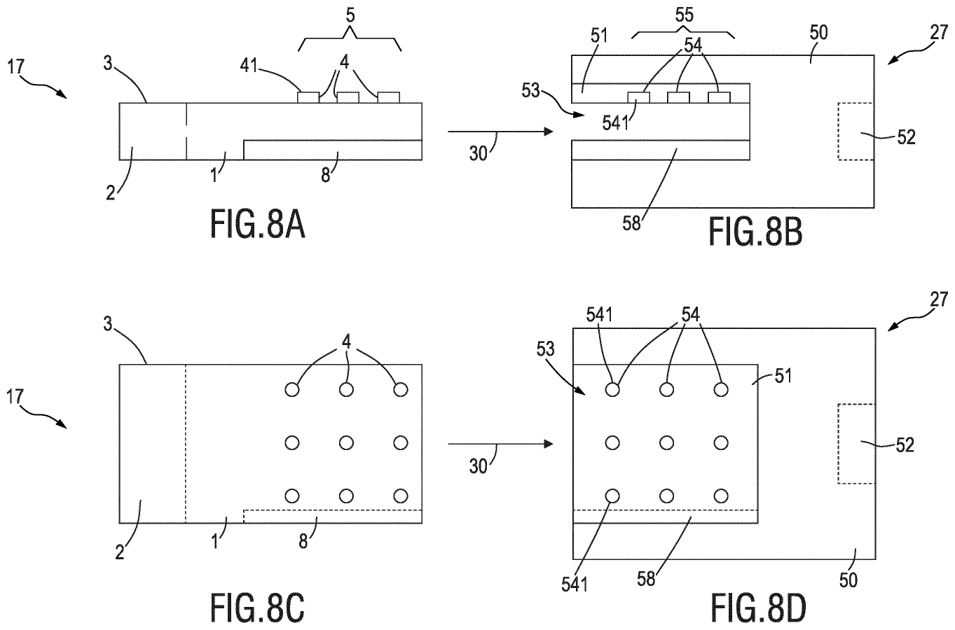

FIG. 8 shows an eighth embodiment of a multi-pin connector plug 17 and socket 27 according to the present invention. In this embodiment the multi-pin connector plug 17 has an asymmetrical mechanical design to allow coupling with said multi-pin connector socket 27 only in one predetermined position of said multi-pin connector plug 17. For instance, at one side of the multi-pin connector plug 17 a bar or protrusion 8 is provided that corresponds with a protrusion or bar 58 on one side of the opening 53 of the multi-pin connector socket 27 in such a way that the multi-pin connector plug 17 can only be inserted into the multi-pin connector socket 27 at one predetermined position of the multi-pin connector plug 17. This prevents wrong insertion and thus a wrong interpretation of signals exchanged between plug 17 and socket 27.

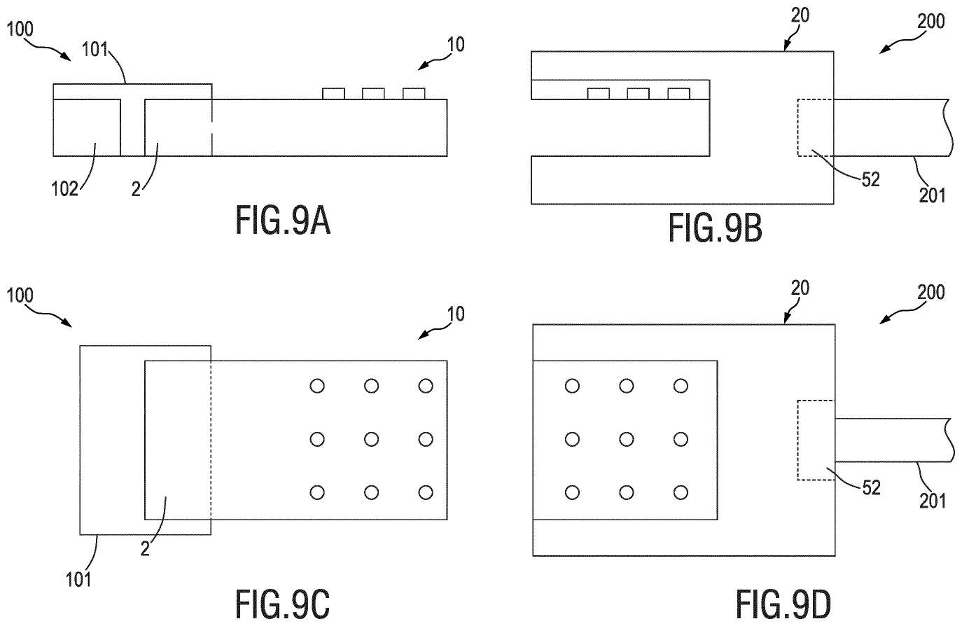

FIG. 9 shows an embodiment of a wearable device 100 and a multi-pin socket arrangement 200 according to the present invention. The wearable device 100 comprises a functional unit 101 for performing a predetermined function and a multi-pin connector plug disclosed herein, whose plug interface 2 is connected with said functional unit 101 for input of signals from and/or output of signals to said functional unit 101, said signals including one or more power supply signals. The functional unit 101 may comprises one or more sensors 102 for sensing one or more sensor signals, and said multi-pin connector plug may then be configured for output of said sensor signals sensed by said one or more sensors and for input said one or more power supply signals for power supply of said function unit 101. Preferably, the functional unit 101 is arranged on said carrier plate 1.

The multi-pin connector socket arrangement 200 comprises a coupling element 201, such as a cable and/or a power supply unit and/or a signal processing unit and/or a wireless signal interface, and a multi-pin connector socket 23 as disclosed herein, whose socket interface 52 is connected with said coupling element 201 for input of signals from and/or output of signals to coupling element 201, said signals including one or more power supply signals.

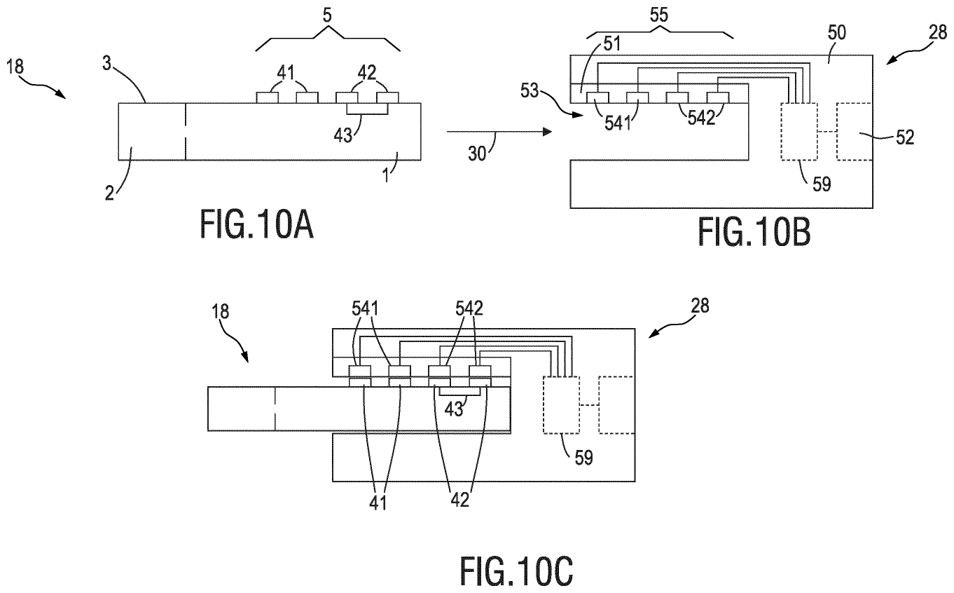

FIG. 10 shows a ninth embodiment of a multi-pin connector plug 18 and socket 28 according to the present invention, which is similar to the fifth and sixth embodiments shown in FIGS. 5 and 6. The multi-pin connector plug 18 comprises, when considering only one row of plug connection pads 4, two plug power supply connection pads 41 and two plug coupling pads 42, which are short-circuited, e.g. by use of a galvanic connection 43. The multi-pin connector socket 28 comprises two socket power supply connection pads 541 and two socket coupling pads 542. The two socket power supply connection pads 541 and two socket coupling pads 542 are separately connected to a power management unit 59, which receives the power supply e.g. from the interface 52. The power management unit 59 is hereby configured such that the power is only supplied to the two socket power supply connection pads 541 and from them to the two plug power supply connection pads 41 if the two socket coupling pads 542 are short-circuited. This is only the case if the plug 18 is completely inserted into the socket, in which position the two socket coupling pads 542 are short-circuited via the two plug coupling pads 42 and the galvanic connection 43. In this way it is ensured that the plug 18 is power free as long as it is not completely inserted into the socket 28.

In an exemplary embodiment 24 connections are provided at the multi-pin connector plug and socket for the desired application, e.g. for connecting a sensor to a measurement module or a patient monitor. A 24-pin connector plug may thus be implemented as flat connector with printed plug connection pads (e.g. of copper) on one or both (opposite) flat surfaces, e.g. with a 6×4 grid of connector pads.

In summary, the proposed embodiments of the connector plugs and sockets do not only show good alignment between the connection pads and the connections, but also good electrical contact. To allow proper functioning special measures may be taken as explained above. In particular, to prevent short circuits during insertion different kinds of layout are disclosed, as particularly illustrated in FIGS. 1 to 3 so that the current can only flow (e.g. to power up a sensor) once the plug is completely inserted into the socket. To prevent wrong insertion of the plug into the sensor an asymmetrical design of the plug and socket may be applied. Additionally, the plug can be designed like a “snap or crocodile” connection to secure the plug manually. In this way the plug or the complete wearable device including the plug (i.e. the disposable part) can be used without a physical connector and therefore will be very cheap. The non-disposable part (i.e. the socket) that is e.g. connected to a cable can be very small (e.g. 27 mm×13 mm×10 mm, 24 connections) and cheap as well.

The present invention can generally be applied in any situation where small, low cost connectors and low cost sensors are needed, such as multi-lead ECG sensors, multi-lead EEG sensors, core body temperature sensors, etc.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

Any reference signs in the claims should not be construed as limiting the scope.

1. A multi-pin connector plug for coupling with a multi-pin connector socket along a coupling direction, said multi-pin connector plug comprising:
a carrier plate,
a plug interface arranged in an interface area of the carrier plate for input of signals from and/or output of signals to a coupled device, said signals including one or more power supply signals, and
a plurality of plug connection pads arranged in a two-dimensionally distributed manner in a connection pad area of the carrier plate for input of signals from and/or output of signals to said multi-pin connector socket,
said plug connection pads including one or more plug power supply connection pads for input of said one or more power supply signals from and/or output of said one or more power supply signals to corresponding socket power supply connection pads of said multi-pin connector socket,
wherein said one or more plug power supply connection pads are arranged either at a front face of the connection pad area of the carrier plate, or at the largest distance from the front face of the connection pad area of the carrier plate among the plug connection pads, or in one or more rows parallel to said coupling direction in which no other plug connection pads are arranged.

2. The multi-pin connector plug as claimed in claim 1,
wherein said plug connection pads include at least two plug coupling pads, which are short-circuited and arranged for short-circuiting at least two corresponding socket coupling pads of said multi-pin connector socket if said multi-pin connector plug is correctly coupled with said multi-pin connector socket, wherein current can only flow through said one or more plug power supply connection pads and said socket power supply connection pads if said at least two plug coupling pads are short-circuiting said at least two corresponding socket coupling pads.

3. The multi-pin connector plug for coupling with a multi-pin connector socket along a coupling direction, said multi-pin connector plug comprising:
a carrier plate,
a plug interface arranged in an interface area of the carrier plate for input of signals from and/or output of signals to a coupled device, said signals including one or more power supply signals, and
a plurality of plug connection pads arranged in a two-dimensionally distributed manner in a connection pad area of the carrier plate for input of signals from and/or output of signals to said multi-pin connector socket,
said plug connection pads including one or more plug power supply connection pads for input of said one or more power supply signals from and/or output of said one or more power supply signals to corresponding socket power supply connection pads of said multi-pin connector socket, and
said plug connection pads including at least two plug coupling pads, which are short-circuited and arranged for short-circuiting at least two corresponding socket coupling pads of said multi-pin connector socket if said multi-pin connector plug is correctly coupled with said multi-pin connector socket, wherein current can only flow through said one or more plug power supply connection pads and said socket power supply connection pads if said at least two plug coupling pads are short-circuiting said at least two corresponding socket coupling pads.

4. The multi-pin connector plug as claimed in claim 1,
wherein plug connection pads are arranged on opposite surfaces of said carrier plate.

5. The multi-pin connector plug as claimed in claim 1,
wherein said carrier plate is made of a flexible material, in particular a flexible foil.

6. The multi-pin connector plug as claimed in claim 5,
wherein part of the carrier plate is folded back by 180° so that plug connection pads are arranged on opposite surfaces of said carrier plate.

7. The multi-pin connector plug as claimed in claim 1,
wherein said multi-pin connector plug has an asymmetrical mechanical design to allow coupling with said multi-pin connector socket only in one predetermined position of said multi-pin connector plug.

8. A wearable device comprising:
functional unit for performing a predetermined function and
a multi-pin connector plug as claimed in claim 1, whose plug interface is connected with said functional unit for input of signals from and/or output of signals to said functional unit, said signals including one or more power supply signals.

9. A wearable device as claimed in claim 8, wherein said functional unit comprises one or more sensors for sensing one or more sensor signals and wherein said multi-pin connector plug is configured for output of said sensor signals sensed by said one or more sensors and for input said one or more power supply signals for power supply of said function unit.

10. A wearable device as claimed in claim 9, wherein said functional unit is arranged on said carrier plate.

11. A multi-pin connector socket for coupling with a multi-pin connector plug along a coupling direction, said multi-pin connector socket comprising:
a socket casing having a plug opening for insertion of said multi-pin connector plug,
a connection plate arranged on one side of said plug opening,
a socket interface for input of signals from and/or output of signals to a coupling element, said signals including one or more power supply signals, and
a plurality of socket connection pads arranged in a two-dimensionally distributed manner in a connection pad area of the connection plate for input of signals from and/or output of signals to said multi-pin connector plug,
said socket connection pads including one or more socket power supply connection pads for input of said one or more power supply signals from and/or output of said one or more power supply signals to corresponding plug power supply connection pads of said multi-pin connector plug,
wherein said one or more socket power supply connection pads are arranged either at a rearward end surface of the plug opening, or at the shortest distance from the forward entrance of said plug opening among the socket connection pads, or in one or more rows parallel to said coupling direction in which no other socket connection pads are arranged.

12. A multi-pin connector socket as claimed in claim 11,
wherein said socket connection pads include at least two socket coupling pads, which are short-circuited and arranged for short-circuiting at least two corresponding plug coupling pads of said multi-pin connector plug if said multi-pin connector socket is correctly coupled with said multi-pin connector plug, wherein current can only flow through said one or more socket power supply connection pads and said plug power supply connection pads if said at least two socket coupling pads are short-circuiting said at least two corresponding plug coupling pads.

13. A multi-pin connector socket for coupling with a multi-pin connector plug along a coupling direction, said multi-pin connector socket comprising:
a socket casing having a plug opening for insertion of said multi-pin connector plug,
a connection plate arranged on one side of said plug opening,
a socket interface for input of signals from and/or output of signals to a coupling element, said signals including one or more power supply signals, and
a plurality of socket connection pads arranged in a two-dimensionally distributed manner in a connection pad area of the connection plate for input of signals from and/or output of signals to said multi-pin connector plug, said socket connection pads including one or more socket power supply connection pads for input of said one or more power supply signals from and/or output of said one or more power supply signals to corresponding plug power supply connection pads of said multi-pin connector plug,
wherein said socket connection pads include at least two socket coupling pads, which are short-circuited and arranged for short-circuiting at least two corresponding plug coupling pads of said multi-pin connector plug if said multi-pin connector socket is correctly coupled with said multi-pin connector plug,
wherein current can only flow through said one or more socket power supply connection pads and said plug power supply connection pads if said at least two socket coupling pads are short-circuiting said at least two corresponding plug coupling pads.

14. A multi-pin connector socket as claimed in claim 11,
comprising a further connection plate arranged on a side of said plug opening opposite the connection plate, wherein a plurality of socket connection pads are arranged in a two-dimensionally distributed manner in a connection pad area of said further connection plate.

15. A multi-pin connector socket arrangement comprising:
a coupling element, in particular a cable and/or a power supply unit and/or a signal processing unit and/or a wireless signal interface,
a multi-pin connector socket as claimed in claim 11, whose socket interface is connected with said coupling element for input of signals from and/or output of signals to coupling element, said signals including one or more power supply signals.
